(19) United States
(12) Patent Application Publication
(10) Pub. No.: US 2008/0165673 A1
(43) Pub. Date: Jul. 10, 2008

(54) SYSTEM AND METHOD FOR DEMODULATING DATA IN AN ORTHOGONAL FREQUENCY DIVISION MODULATION SYSTEM

(75) Inventors: COLIN D. FRANK, PARK RIDGE, IL (US); ALAN P. CONRAD, ST. CHARLES, IL (US); ROBERT J. CORKE, GLEN ELLYN, IL (US); JORGE L. SEOANE, ALGONQUIN, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/621,349

(22) Filed: Jan. 9, 2007

(51) Int. Cl. H04Q 7/00

(52) U.S. Cl. 370/210

(57) ABSTRACT

First incoming data comprising at least one OFDM symbol is received (302). A plurality of timing relationships is determined and each of the plurality of timing relationships relates to an alignment window of a fast Fourier transform (FFT) (304). Each of the plurality of timing relationships is applied to the first incoming data (306) and a plurality of achievable interference metrics associated with the first incoming data is responsively determined (308). Each of the plurality of achievable interference metrics is associated with a selected one of the plurality of timing relationships. The preferred interference metric is chosen from amongst the plurality of achievable interference metrics.

### TECHNICAL FIELD

The field of the invention relates to communications made within networks and achieving synchronization for these communications.

### BACKGROUND

Different protocols have been used to transmit information within Orthogonal Frequency Division Modulation (OFDM) systems. In one example, Institute of Electrical and Electronic Engineers (IEEE) 802.11 standard protocols are used to facilitate the transmission of OFDM symbols in OFDM networks. In this case, the OFDM symbols include a plurality of subcarriers and groups of symbols can be transmitted with a preamble in the form of a frame or packet.

Timing synchronization between transmitters and receivers operating within OFDM networks affects the performance of the network. For instance, poor timing synchronization can severely limit maximum achievable signal-to-interference (S/I) ratio at the receiver in the presence of multipath. In the event of poor timing synchronization, the ability to use certain modulation techniques (e.g., 16 and 64-Quadrature Amplitude Modulation (QAM)) may be greatly reduced. In some cases, the link between a transmitter and receiver is rendered completely unusable when timing synchronization is poor.

Previous attempts to improve timing synchronization have focused upon identifying a peak cross-correlation of the received signals. For instance, the receiver may advance a fast Fourier transform (FFT) by a predetermined number (e.g., six) of samples from the peak cross-correlation to improve synchronization. Unfortunately, these methods are ad hoc in nature and do not satisfy any general criteria for optimality. As a result, adequate timing synchronization has been difficult or impossible to achieve in many environments for previous systems.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a system for selecting a timing relationship according to various embodiments of the present invention.

FIG. 2 is a block diagram of a device for selecting a timing relationship according to various embodiments of the present invention.

FIG. 3 is a flowchart of an approach for selecting a timing relationship according to various embodiments of the present invention.

FIG. 4 is a call flow diagram of an approach for selecting a timing relationship according to various embodiments of the present invention.

FIG. 5 is a graph of path delay after the approaches described herein have been applied to a receiver according to various embodiments of the present invention.

### DETAILED DESCRIPTION

Before describing in detail embodiments that are in accordance with the present invention, it should be observed that the embodiments reside primarily in combinations of method steps and apparatus components related to a method and apparatus for demodulating data in an OFDM system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

It will be appreciated that embodiments of the invention described herein may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for demodulating data in an OFDM system described herein. The non-processor circuits may include, but are not limited to, a radio receiver, a radio transmitter and user input devices. As such, these functions may be interpreted as steps of a method to perform the demodulation of data in an OFDM system described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, a system and method are provided that select optimum timing relationships in order to process incoming data in OFDM systems. The approaches described herein are easy to implement and provide for improved system performance. Consequently, user satisfaction with the system is also enhanced.

In many of these embodiments, first incoming data comprising at least one OFDM symbol is received. A plurality of timing relationships is determined and each of the plurality of timing relationships relates to an alignment window of a fast Fourier transform (FFT).

Each of the plurality of timing relationships is applied to the first incoming data and a plurality of achievable interference metrics associated with the first incoming data is responsively determined. Each of the plurality of achievable interference metrics is associated with a selected one of the plurality of timing relationships.

A preferred interference metric is chosen from amongst the plurality of achievable interference metrics and a preferred timing relationship is identified from amongst the plurality of timing relationships. The preferred timing relationship is associated with the preferred interference metric.

Many approaches may be used to determine the preferred interference metric. For example, the preferred interference metric may be the maximum achievable interference metric or the minimum achievable interference metric.

Second incoming data may also be received and this second incoming data may include a sequence of OFDM symbols. This data may be demodulated using the preferred timing relationship.

Various types of interference metrics may also be used. For example, the achievable interference metrics may be a Signal/Interference (S/I) ratio. Other examples of interference metrics are possible.

Thus, approaches are provided that select optimum timing relationships that are used to demodulate incoming data in OFDM systems. The approaches described herein are easy to implement and provide for improved system performance. Consequently, user satisfaction with these systems is also enhanced. Those skilled in the art will realize that the above recognized advantages and other advantages described herein are merely exemplary and are not meant to be a complete rendering of all of the advantages of the various embodiments of the present invention.

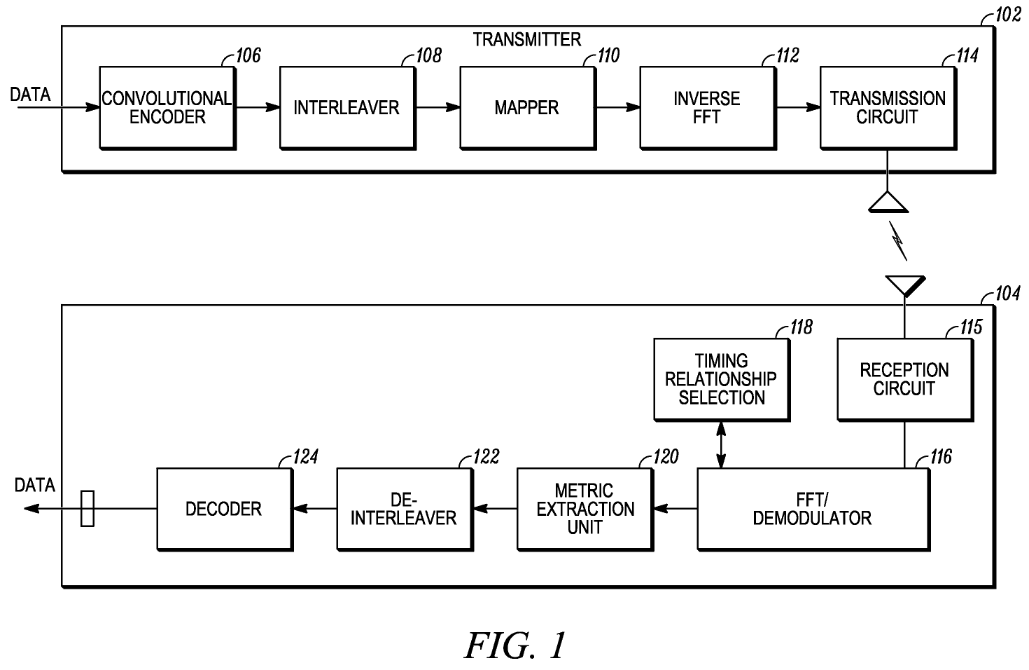

Referring now to FIG. 1, one example of a system for achieving optimal timing synchronization is described. The system includes a transmitter 102 and a receiver 104. The transmitter 102 includes a convolutional encoder 106, an interleaver 108, a mapper 110, an inverse fast Fourier transform (FFT) 112, and a transmission circuit 114. The receiver 104 includes a reception circuit 115, a FFT/demodulator 116, a timing relationship selection module 118, a metric extraction unit 120, a de-interleaver 122, and a decoder 124.

At the transmitter 102, binary data is received by the convolutional encoder 106. The convolutional encoder 106 encodes the binary data and outputs a sequence of binary code symbols. Next, the interleaver 108 interleaves the data so that bursts of unreliable symbols that may be present in the received data are randomly located when presented to the decoder. The encoded and interleaved data is next processed by the mapper 110, which divides the data into groups and converts the data into complex numbers as used in Binary Phase Shift Keying (BPSK) modulation, Quadrature Phase Shift Keying (QPSK) modulation, 16 Quadrature Amplitude Modulation (QAM), 64 QAM, or any other type of modulation technique, thereby, generating one subcarrier modulation symbol per subcarrier for a plurality of subcarriers associated with an OFDM symbol. The Inverse FFT 112 transforms the subcarrier modulation symbol sequence to a sampled time sequence. In one implementation a cyclic prefix is prepended to the sampled time sequence. In other implementations, a cyclic suffix can be appended. The transmission circuit 114 includes amplifiers and/or filters to transmit the information across a transmission medium such as an air interface.

At the receiver 104, the data transmitted from the transmitter 102 is received at the reception circuit 115, which has amplifiers and/or filters to receive the information being sent over the transmission medium in the form of a sampled time sequence. The FFT/demodulator 116 demodulates the data using a FFT, thereby, transforming the sampled time sequence to a sequence of subcarrier modulation sequence. During this process, a window of samples of the received data are correlated with the complex conjugate of the complex sinusoid corresponding to each data subcarrier, and outputs a sequence of binary code symbols. The particular timing relationship that is used to demodulate the data is selected by the timing relationship selection module 118 and this process is described in greater detail herein. The metric extraction unit 120 determines the likelihood of a predetermined bit pattern occurring within the FFT output. For example, the metric extraction unit may determine the likelihood that a zero or one was transmitted for each binary code symbol. The de-interleaver 122 performs the reverse function of the interleaver 106 at the transmitter 102 (i.e., restoring the data to a non-interleaved state). Finally, the decoder 124 (e.g. a Viterbi decoder) decodes the deinterleaved binary code symbols, generating binary data that can be, for instance, presented to a user for usage.

In one example of the operation of the system of FIG. 1, first incoming data comprising a packet preamble and at least one OFDM symbol is received at the receiver 104. A plurality of timing relationships is determined by the timing relationship selection module 118 and each of the plurality of timing relationships relates to an alignment window of a fast Fourier transform (FFT) with the received data.

Each of the plurality of timing relationships is applied to the first incoming data at the demodulator 116 and a plurality of achievable interference metrics associated with the first incoming data is responsively determined. Each of the plurality of achievable interference metrics is associated with a selected one of the plurality of timing relationships.

A preferred interference metric is chosen from amongst the plurality of achievable interference metrics by the timing relationship selection module 118 a preferred timing relationship is identified from amongst the plurality of timing relationships. The preferred timing relationship is associated with the preferred interference metric. As described herein, a variety of approaches may be used to determine the preferred interference metric. For example, the preferred interference metric may be the maximum achievable interference metric or the minimum achievable interference metric. Second incoming data may be received at the receiver 104 (at the reception circuit 115) and this second incoming data may include a sequence of OFDM symbols. This data is demodulated by the FFT/Demodulator 116 using the preferred timing relationship. Also as discussed herein, various types of interference metrics may also be used. For example, the achievable interference metrics may be the S/I ratio. Other examples of interference metrics are possible.

The maximum achievable S/I is a function of the composite channel and the receiver timing. [symbol] ₘₐₓ may be defined as:

$$〈 S 〉 / {〈 I 〉}_{max} = \frac{E ( S )}{{lim}_{{N}_{0} \to 0} E ( I )} , \qquad ( 1 )$$

where E(S) is the expectation average over the 48 data subcarriers.

Another measure of performance is actual distribution of a random variable (S/I)ₘₐₓ, which may be defined as

$${( S / I )}_{max} = {lim}_{{N}_{0} \to 0} E ( \frac{S}{I} ) . \qquad ( 2 )$$

where E(S/I) is an expectation average of the ratio over the 48 data subcarriers. Evaluation of the distribution of (S/I)ₘₐₓ may require simulation.

The preamble at the start of the packet or frame may be used to estimate a channel over which incoming data us received and chose the optimum timing synchronization, and, in one approach, includes two repetitions of a common OFDM symbol. In one example, the preamble has a prefix with length equal to twice that of the OFDM data symbols that follow. Thus, for a 20 MHz channel, the cyclic prefix of the preamble is 1.6 microseconds, while the cyclic prefix of subsequent OFDM data symbols comprising the frame is 0.8 microseconds. For the 20 MHz channel, the presumed sampling rate of the receiver is 20 MHz, or equivalently 20 million samples per second. In this example, the receiver 104 estimates the appropriate timing, computes the FFT of two consecutive blocks of 64 preamble samples, and sums the two vector outputs. The vector channel estimate is formed by dividing this sum by twice the FFT of the preamble.

Because the cyclic prefix for a 20 MHz channel preamble is 1.6 microseconds, a channel estimation or timing synchronization algorithm can measure a composite channel having a duration of 1.6 microseconds without interference from any source other than Additive Gaussian White Noise (AGWN). The composite channel comprises the convolution of the transmit filter, the receive filter and the propagation channel between the transmitter and receiver. In one example, neither inter-symbol interference from the preceding timing synchronization signal nor inter-tone interference due to loss of periodicity over the FFT interval interferes with the channel measurement so long as the duration of the composite channel is no greater than 33 samples at a sampling rate of 20 MHz.

When the preamble-based channel estimate is converted from the frequency domain to the time domain at the FFT/Demodulator 116, all 64 samples of the impulse response will be non-zero due to the presence of AWGN in the preamble measurement, and this is independent of the presence or absence of intersymbol and inter-tone interference. If the span of the composite channel is known to be less than some value—e.g., 0.8 or 1.6 microseconds—the time-domain coefficients outside of the known span can be forced to zero. The FFT of this modified channel response is then used to equalize the received signal in the frequency domain.

In another example, let the sequence {fᵢ} denote the impulse response of the composite channel sampled at 20 MHz, or more generally, at the inverse of the bandwidth of the OFDM signal. In the 802.11a standard, the preamble used to measure the channel has a period of 64, a cyclic prefix of length 32, and a total length of 160. The channel is measured by first taking two successive FFT's on adjacent blocks of 64 samples. The two FFT's are averaged, and the resulting vector is divided by the FFT of the periodic length-64 preamble sequence to produce vector of complex channel gain estimates for the OFDM subcarriers. A similar result is produced if the two consecutive FFT's were each first divided by the FFT of the preamble and then averaged.

Let {pᵢ}ᵢ₌₀¹⁵⁹ denote the length 160 preamble sequence, and let the sequence {rₖ} denote the convolution of the composite channel and the preamble given by

$${r}_{k} = {p}_{k} * {f}_{k} = {\sum }_{m} {f}_{m} {p}_{k - m} . \qquad ( 3 )$$

Let the length-64 vectors FFT₁(j) and FFT₂ (j) denote the result of FFT's operating on the received sample vectors {rₖ}ₖ₌ⱼ^{j+63} and {rₖ}ₖ₌ⱼ₊₆₄^{j+127} respectively, and let the inverse FFT of the mean of these two vectors be denoted by gⱼ and gⱼ₌₆₄, where

(g_{j,0}, g_{j,1}, g_{j,2}, . . . g_{j,63}) (4a)

and

(g_{j+64,0}, g_{j+64,1},g_{j+64,2}, . . . g_{j+64,63}). (4b)

It can be shown that,

$$\begin{matrix}{g}_{k , l} = {\sum }_{i} {f}_{k + l - 32 - 64 i} w ( 32 + 64 i - l ) \\ = {\sum }_{i} {f}_{k + l - 96 - 64 i} w ( 96 + 64 i - l ) ,\end{matrix} \qquad ( 5 )$$

where 0≦l≦63, and the function w(.) is given by

$$w ( k ) = \frac{1}{64} max ( 0 , min ( 159 , k + 64 ) - max ( 0 , k ) ) . \qquad ( 6 )$$

The average of the two preamble-based channel estimates has a mean vector μ_preamble given by

$$\begin{matrix}{μ\_preamble}_{j} ≡ ( {m}_{j , 0} , {m}_{j , 1} , {m}_{j , 2} , … , {m}_{j , 63} ) \\ = \frac{1}{2} ( ( {g}_{j , 0} , {g}_{j , 1} , {g}_{j , 2} , … , {g}_{j , 63} ) + \\ ( {g}_{j + 64 , 0} , {g}_{j + 64 , 1} , {g}_{j + 64 , 2} , … , {g}_{j + 64 , 63} ) ) ,\end{matrix} \qquad ( 7 )$$

which can be expressed as

$${μ\_preamble}_{j , k} = \frac{1}{2} \cdot {\sum }_{i} {f}_{j + k - 32 - 64 i} ( w ( 32 + 64 i - k ) + w ( 96 + 64 i - k ) ) \qquad ( 8 )$$

If it is assumed that the channel f is causal (fᵢ=0 for I<0) and fᵢ=0) for i>32, and select j=32, then

μ_preamble₃₂=(f₀, f₁, . . . , f₃₂, 0, . . . , 0), (9)

and the mean of the inverse FFT of the preamble-based frequency-domain channel measurement is equal to the actual channel impulse response so long as the length of the channel impulse response is less than 34 samples. Thus, using the current approaches, the receiver 104 can provide a valid preamble-based measurement of any channel impulse response with a length of fewer than 34 samples, even though the cyclic prefix for the data symbols has a length of only 16 samples.

If the channel response is longer than 33 samples, then the mean of the channel estimate is affected both by the timing acquisition field preceding the preamble as well as by inter-tone interference, so that the expression given above is only an approximation of the channel estimate mean. Since the timing acquisition field is fixed and not randomized by the data, the interference cannot be treated as a zero-mean random variable. However, if only a single measurement of the channel is adequate (one measurement rather than two measurements averaged together), then the channel can be measured once with 63≦j≦96, and the measurement of any causal channel f having a length not greater than 64 samples will have a mean equal to the channel mean f.

If both the timing acquisition field preceding the preamble and the following signal field are treated as random zero mean signals (though at least the timing acquisition field is not, since it is a deterministic sequence), and the inter-tone interference is modeled as having zero mean, then the expression given in (8) for the mean of the channel measurement can be used for any channel length. Using this expression, and with the assumption that the preceding timing signal and following signal field can be treated as random interference, it can be shown that the preamble-based channel measurement for j=32 has a mean given by the following sum of length-64 vectors:

$${μ\_preamble}_{32} = ( {f}_{0} , {f}_{1} , … , {f}_{32} , \frac{127}{128} {f}_{33} , \frac{126}{128} {f}_{34} , … , \frac{97}{128} {f}_{63} ) + ( \frac{96}{128} {f}_{64} , \frac{95}{128} {f}_{65} , … , \frac{33}{128} {f}_{127} ) + ( \frac{32}{128} {f}_{128} , \frac{31}{64} {f}_{129} , … , \frac{1}{64} {f}_{159} , 0 , 0 , … , 0 ) + ( \frac{64}{128} {f}_{- 64} , \frac{65}{128} {f}_{- 63} , … , \frac{127}{128} {f}_{- 1} ) + ( 0 , \frac{1}{128} {f}_{- 127} , \frac{2}{128} {f}_{- 126} , … , \frac{63}{128} {f}_{- 65} ) \qquad ( 10 )$$

The mean of the measurement for arbitrary j is given by equation (8) above.

For the data symbols, the mean channel is the same as the measured channel, so long as the channel impulse response is no longer than 17 samples in duration (and the receiver timing is correct). However, if the channel is longer than 17 samples, the means of the complex subcarrier gains for the data symbols are not equal to those measured using the preamble. In particular, if the timing of the FFT for the data symbol is the same as for the preamble measurement, then the mean of the inverse FFT of the frequency-domain channel response seen by the data symbols is given by the following sum of length-64 vectors:

$$μ\_data = ( {f}_{0} , {f}_{1} , … , {f}_{15} , {f}_{16} , \frac{63}{64} {f}_{17} , … , \frac{17}{64} {f}_{63} ) + ( \frac{16}{64} {f}_{64} , \frac{15}{64} {f}_{65} , … , \frac{1}{64} {f}_{79} , 0 , 0 , … , 0 ) + ( 0 , \frac{1}{64} {f}_{- 63} , … \frac{62}{64} {f}_{- 2} , \frac{63}{64} {f}_{- 1} ) \qquad ( 11 )$$

where in this expression, the length of the channel response has not been limited to any finite interval. The difference between the mean of the preamble-based channel measurement and the mean of the channel observed by the data symbols is then given by the following sum of length-64 vectors:

$$μ\_error = \\ ( 0 , … , 0 , \frac{1}{64} {f}_{17} , \frac{2}{64} {f}_{18} , … , \frac{16}{64} {f}_{32} , \frac{33}{128} {f}_{33} , \frac{34}{128} {f}_{34} , … , \frac{63}{128} {f}_{63} ) + ( \frac{64}{128} {f}_{64} , \frac{65}{128} {f}_{65} , … , \frac{79}{128} {f}_{79} , \frac{80}{128} {f}_{80} , \frac{79}{128} {f}_{81} , … , \frac{33}{128} {f}_{127} ) + ( \frac{32}{128} {f}_{128} , \frac{31}{64} {f}_{129} , … , \frac{1}{64} {f}_{159} , 0 , 0 , … , 0 ) + ( \frac{64}{128} {f}_{- 64} , \frac{63}{128} {f}_{- 63} , … , \frac{1}{128} {f}_{- 2} \frac{1}{128} {f}_{- 1} ) + ( 0 , \frac{1}{128} {f}_{- 127} , \frac{2}{128} {f}_{- 126} , … , \frac{63}{128} {f}_{- 65} ) \qquad ( 12 )$$

In other examples, where the S/I ratio is the interference metric used, the preamble-based channel measurement is used in the receiver 104, the resulting error, averaged across all subcarriers, is equal to the norm squared of the energy of μ_error given in (12). Conversely, with decision directed channel estimation, the mean of the channel estimate is equal to μ_data. Thus, with the preamble-based channel measurement, the max S/I, averaged across the subcarriers, is given by

$$〈 S 〉 / {〈 I 〉}_{max} = \frac{{‖ μ\_data ‖}^{2}}{{\sum }_{i} {γ}_{i} {‖ {f}_{i} ‖}^{2} + {‖ μ\_error ‖}^{2}} , \qquad ( 13 )$$

whereas, for decision-directed channel estimation, the max S/I is given by

$$〈 S 〉 / {〈 I 〉}_{max} = \frac{{‖ μ\_data ‖}^{2}}{{\sum }_{i} {γ}_{i} {‖ {f}_{i} ‖}^{2}} . \qquad ( 14 )$$

where γₖ is a multipath interference coefficient defined in Equations (30), (31), and (32) below.

The value of [symbol] depends on both the composite channel f and the receiver timing, where the receiver timing is characterized by the alignment of the FFT interval relative to the composite channel. As used herein, the definition of the time index 0 for the composite channel f is completely arbitrary as long as two conditions are met with respect to the alignment of the receiver timing and the measurement of the channel.

In this example, for data symbols, the FFT must be aligned with the 17-th sample of the desired OFDM symbol, where the indices of the samples of the received OFDM symbol are defined relative to the composite channel coefficient that has been assigned index 0.

The channel measurement is performed on received samples 32-159 of the preamble, where the indices of the received preamble are defined relative to the composite channel coefficient that has been assigned index 0.

If the above conditions are not satisfied, then the definition of μ_preamble should be modified, the definition of μ_data should be modified, the definitions of μ_error should be modified.

If the conditions are met with respect to the definition of μ_data and μ_error, the max S/I expressions (13) and (14) can be evaluated for all possible assignments of the time index 0 relative to the composite channel. Consequently, the optimal receiver timing can be defined as the assignment of index 0 which yields the greatest value of [symbol] ₘₐₓ.

In the above mentioned examples, only deterministic channels have been considered. However, [symbol] ₘₐₓ can also be evaluated for a composite channel for which the propagation channel is random. For a random propagation channel, the expressions for [symbol] in (13) and (14) become

$$〈 S 〉 / {〈 I 〉}_{max} = \frac{E ( {‖ μ\_data ‖}^{2} )}{{\sum }_{i} {γ}_{i} E ( {‖ {f}_{i} ‖}^{2} ) + E ( {‖ μ\_error ‖}^{2} )} . \qquad ( 15 )$$

for preamble-based channel estimation, and

$$〈 S 〉 / {〈 I 〉}_{max} = \frac{E ( {‖ μ\_data ‖}^{2} )}{{\sum }_{i} {γ}_{i} E ( {‖ {f}_{i} ‖}^{2} )} \qquad ( 16 )$$

for decision-directed channel estimation. The expressions in (18) and (19) can be evaluated so long as it is possible to evaluate

E(fⱼfₖ*) for all j,k. (17)

As noted, the composite channel f is the convolution of the transmit filter, the propagation channel, and the receiver filter. Let the sequence r={ . . . , rₖ₋₁, rₖ, rₖ₊₁, . . . } denote the sampled convolution of the transmitter and receiver filters, and let the sequence h={ . . . h_{k-1, h}ₖ, hₖ₊₁, . . . } denote the sampled random multipath channel, so that the composite channel f can be written as the convolution

f=r*h. (18)

With the above, it follows that the energy of the k-th component of f can be written as

$$\begin{matrix}E ( {\vert {f}_{k} \vert}^{2} ) = {\sum }_{n} {r}_{n} {h}_{k - n} ( {\sum }_{m} {r}_{m} {h}_{k - m} ) \\ = {\sum }_{n} {\sum }_{m} {r}_{n} {r}_{m}^{*} E ( {h}_{k - n} {h}_{k - m}^{*} )\end{matrix} \qquad ( 19 )$$

Typically, the propagation channel is modeled such that

$$E ( {h}_{n} {h}_{m}^{*} ) = \{ \begin{matrix}{σ}_{n}^{2} & n = m \\ 0 & else\end{matrix} , \qquad ( 20 )$$

where σₙ² denotes the power of hₙ, so that

$$\begin{matrix}E ( {\vert {f}_{k} \vert}^{2} ) = {\sum }_{n} {\vert {r}_{n} \vert}^{2} {σ}_{k - n}^{2} . \\ Note also that & ( 21 ) \\ \begin{matrix}E ( {f}_{k} {f}_{j}^{*} ) = {\sum }_{n} {r}_{n} {{h}_{k - n} ( {\sum }_{m} {r}_{m} {h}_{j - m} )}^{*} \\ = {\sum }_{n} {\sum }_{m} {r}_{n} {r}_{m}^{*} E ( {h}_{k - n} {h}_{j - m}^{*} )\end{matrix} , \\ and thus finally & ( 22 ) \\ \begin{matrix}E ( {f}_{k} {f}_{j}^{*} ) = {\sum }_{n} {r}_{n} {r}_{n + j - k}^{*} {σ}_{k - n}^{2} \\ = {\sum }_{m} {r}_{k - m} {r}_{j - m}^{*} {σ}_{m}^{2}\end{matrix} . & ( 23 )\end{matrix}$$

With equations (21) and (23), the quantities ∥fᵢ∥², ∥μ_data∥², ∥μ_error∥² can be evaluated for use in the expressions for [symbol] ₘₐₓ in (15) and (16).

A given modulation and coding combination cannot be used if [symbol] ₘₐₓ for the channel is less than the determined S/I requirement. Conversely, if [symbol] ₘₐₓ for the channel is greater than the required value indicated in Table 1, the modulation and coding combination can be used. However, even when the value of [symbol] ₘₐₓ is such that a given modulation and coding combination can be used, the [symbol] ₘₐₓ limitation still results in an increase in the signal strength required to close the link relative to that required in the absence of any limitation on [symbol] ₘₐₓ. This increase in the required signal strength in the presence of [symbol] ₘₐₓ is referred to as the receiver desensitization.

Let [symbol] _{req} denote the S/I required to achieve the target error rate for a given combination of modulation, coding, and frame length. For this same combination, let P_{req} denote the receiver sensitivity, which is defined as the signal power required at the receiver in order to achieve the target packet error rate. Generally, other interference sources in the receiver (e.g., quantization noise) will also limit the maximum achievable S/I and affect receiver sensitivity P_{req} (especially at higher data rates). However, if the value of [symbol] ₘₐₓ resulting from channel delay spread is significantly less than those resulting from the other interference sources, the receiver desensitization associated with channel delay spread can be evaluated independently of the other sources. Otherwise, if the value of [symbol] ₘₐₓ is not much more restrictive than the S/I limitations associated with the other interference sources, then the other sources may be considered in combination with delay spread interference in the evaluation of receiver desensitization.

If it is assumed that self-interference due to delay spread dominates the self-interference due to other sources, then

$${P}_{req , desense} = \frac{{P}_{req}}{1 - \frac{S / {I}_{req}}{〈 S 〉 / {〈 I 〉}_{max}}} . \qquad ( 24 )$$

The receiver desensitization, D, is defined here as the ratio of the P_{req,desense} and P_{req}, and is given by

$$D = \frac{{P}_{req , desense}}{{P}_{req}} = {( 1 - \frac{S / {I}_{req}}{〈 S 〉 / {〈 I 〉}_{max}} )}^{- 1} . \qquad ( 25 )$$

Since S/I_{req} depends on the link data rate, the receiver desensitization associated with a given value of [symbol] ₘₐₓ also depends on the data rate. As the data rate is increased, S/I_{req} increases, as does receiver desensitization. If, for a given combination of coding, modulation, and frame length, S/I req is greater than [symbol] ₘₐₓ, the combination cannot be used. Conversely, if [symbol] ₘₐₓ is greater than S/I_{req} for a given combination of coding, modulation, and frame length, the combination can be used, but the receiver will typically always be desensitized to some degree. If [symbol] ₘₐₓ>>S/I_{req} then the receiver desensitization is minimal. Conversely, if [symbol] ₘₐₓ≦S/I_{req}+3 dB, then the receiver desensitization is at least 3 dB.

Any degradation of receiver sensitivity can be equated to a reduction in link range using the appropriate path loss exponent. If R and R_{desense} denote the range of the link with and without receiver desensitization, respectively, then the reduction in range is given by:

$$\frac{{R}_{desense}}{R} = {( \frac{1}{D} )}^{\frac{1}{PL}} = {( 1 - \frac{S / {I}_{req}}{〈 S 〉 / {〈 I 〉}_{max}} )}^{\frac{1}{PL}} , \qquad ( 26 )$$

where PL denotes the path loss exponent. Since S/I_{req} increases with data rate, receiver desensitization will also increase with data rate, with the result that the link range of the highest data rates will be the most affected by the introduction of [symbol] ₘₐₓ.

In another example of the system of FIG. 1, the timing relationship selection module 118 computes FFTs for each of two adjacent blocks of 64 received samples. The two FFT vectors are summed element-by-element and the result is divided by the FFT of the preamble. This result represents the frequency response of the channel.

The inverse FFT is taken of the measured frequency response. The channel is shifted (equivalent to shifting of the FFT window) until the following metric is maximized:

$$〈 S 〉 / {〈 I 〉}_{max} = \frac{{‖ μ\_data ‖}^{2}}{{\sum }_{i} {γ}_{i} {‖ {f}_{i} ‖}^{2} + {‖ μ\_error ‖}^{2}} \qquad ( 27 )$$

where

$$\begin{matrix}μ\_data = ( {f}_{0} , {f}_{1} , … , {f}_{15} , {f}_{16} , \frac{63}{64} {f}_{17} , … , \frac{17}{64} {f}_{63} ) + ( \frac{16}{64} {f}_{64} , \frac{15}{64} {f}_{65} , … , \frac{1}{64} {f}_{79} , 0 , 0 , … , 0 ) + ( 0 , \frac{1}{64} {f}_{- 63} , … \frac{62}{64} {f}_{- 2} , \frac{63}{64} {f}_{- 1} ) , & ( 28 ) \\ μ\_error = ( 0 , … , 0 , \frac{1}{64} {f}_{17} , \frac{2}{64} {f}_{18} , … , \frac{16}{64} {f}_{32} , \frac{33}{128} {f}_{33} , \frac{34}{128} {f}_{34} , … , \frac{63}{128} {f}_{63} ) + ( \frac{64}{128} {f}_{64} , \frac{65}{128} {f}_{65} , … , \frac{79}{128} {f}_{79} , \frac{80}{128} {f}_{80} , \frac{79}{128} {f}_{81} , … , \frac{33}{128} {f}_{127} ) + ( \frac{32}{128} {f}_{128} , \frac{31}{64} {f}_{129} , … , \frac{1}{64} {f}_{159} , 0 , 0 , … , 0 ) + ( \frac{64}{128} {f}_{- 64} , \frac{63}{128} {f}_{- 63} , … , \frac{2}{128} {f}_{- 2} \frac{1}{128} {f}_{- 1} ) + ( 0 , \frac{1}{128} {f}_{- 127} , \frac{2}{128} {f}_{- 126} , … , \frac{63}{128} {f}_{- 65} ) & ( 29 )\end{matrix}$$

and γₖ is a multipath interference coefficient given by

γ^{k}=γ_{ISI,k}+γ_{ITI,k}, (30)

where γ_{ISI,k} is the part of the multipath interference coefficient due to intersymbol interference given by

$${γ}_{ISI , k} = \{ \begin{matrix}0 & 0 \leq k \leq 16 \\ {( \frac{k - 16}{64} )}^{2} & 17 \leq k \leq 79 \\ {( \frac{k}{64} )}^{2} & - 63 \leq k \leq - 1 \\ 1 & \vert k \vert \geq 64 and mod ( k , 80 ) \leq 16 \\ \begin{matrix}{( \frac{mod ( k , 80 ) - 16}{64} )}^{2} + \\ {( \frac{80 - mod ( k , 80 )}{64} )}^{2}\end{matrix} & otherwise\end{matrix} \qquad ( 31 )$$

and γ_{ITI,k} is the portion of the multipath interference coefficient due to inter-tone interference given by

$${γ}_{ITI , k} = \{ \begin{matrix}0 & mod ( k , 80 ) \leq 16 \\ \frac{4}{52} {\sum }_{i = 1}^{51} ( 52 - i ) \frac{{sin}^{2} ( π i ( mod ( k , 80 ) - 16 ) / 64 )}{{( 64 )}^{2} {sin}^{2} ( π i / 64 )} & else\end{matrix} \qquad ( 32 )$$

Alternatively, in another approach, the channel is shifted until the following metric is maximized:

$$〈 S 〉 / {〈 I 〉}_{max} = \frac{{‖ μ\_data ‖}^{2}}{{\sum }_{i} {γ}_{i} {‖ {f}_{i} ‖}^{2}} \qquad ( 33 )$$

In general, the mean of the preamble-based channel measurement is not sufficient to determine the composite impulse response. Referring to equation (10) shows that while the preamble-based channel measurement has length 64, its mean in general depends on values of the composite channel impulse response in the sequence {f₋₁₂₇, f₋₁₂₆, . . . f₀, . . . f₁₅₈f₁₅₉} of length 287. However, if the length of the interval over which the channel impulse response non-zero is less than or equal to 64, then there is a one-to-one mapping between the channel impulse response and the mean of the preamble-based channel measurement. For example, if the channel impulse response is zero outside the interval

$$\{ {f}_{16} , {f}_{14} , … , {f}_{0} , … , {f}_{46} , {f}_{47} \} , \\ then {f}_{i} = \{ \begin{matrix}{( {μ\_preamble}_{32} )}_{i} & 0 \leq i \leq 32 \\ ( \frac{159 - i}{128} ) {( {μ\_preamble}_{32} )}_{i} & 33 \leq i \leq 47 \\ ( \frac{128 + i}{128} ) {( {μ\_preamble}_{32} )}_{i} & - 16 \leq i \leq 1 \\ 0 & otherwise\end{matrix} \} \qquad ( 34 )$$

So long as the channel impulse response is known to be zero outside some interval of length 64, the equation (10) can be used to define a one-to-one mapping between the channel impulse response and the mean of the preamble-based channel measurement similar to that in (34). This estimate of the channel impulse response can then used to compute μ_data and μ_terror using equations (29) and (30), respectively.

Since the shift that maximizes the metric is known, the FFT window has been identified, and the FFT window is shifted by this same number of samples. The resulting shift will maximize the maximum S/I attainable in the receiver, [symbol] ₘₐₓ.

If the [symbol] ₘₐₓ is too small, some modulation and coding rates are unusable because the required S/I is greater than [symbol] ₘₐₓ. These modulation and coding rates cannot be used no matter how much transmit power is available. By maximizing [symbol] ₘₐₓ using the present approaches, the set of modulation and coding rates that can be used is increased.

In addition, by maximizing [symbol] ₘₐₓ, the receiver desensitization associated with the [symbol] ₘₐₓ is minimized. Even if the required S/I for a given modulation and coding rate is less than [symbol] ₘₐₓ, the receiver is desensed by

$$D = \frac{{P}_{req , desense}}{{P}_{req}} = {( 1 - \frac{S / {I}_{req}}{〈 S 〉 / {〈 I 〉}_{max}} )}^{- 1} , \qquad ( 35 )$$

and that desensitization becomes worse as the data rate increases and S/I_{req} increases accordingly. By choosing the timing that maximizes [symbol] ₘₐₓ, receiver desensitization is minimized.

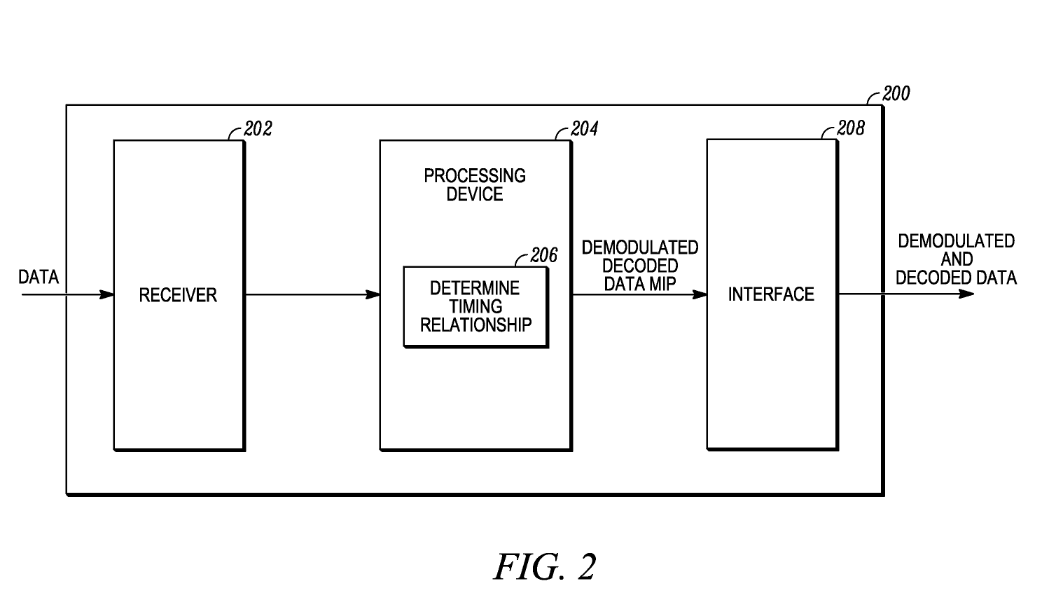

Referring now to FIG. 2, one example of a device 200 for selecting optimum timing relationship is described. The device 200 includes a receiver 202, which receives incoming data such as OFDM symbols. The receiver 202 is coupled to a processing device 204. The processing device 204 includes a determine timing relationship module 206, which may be implemented as hardware, software, or some combination of hardware and software. The processing device 204 is coupled to an interface 208. Device 200 may further include a transmitter and comprise a communication device and operate in accordance with 801.11 standard protocols.

In one example of the operation of the system of FIG. 2, the receiver 202 receives first incoming data. The processing device 204 is programmed to determine a plurality of timing relationships using the determine timing relationship module 206. Each of the plurality of timing relationships relates to an alignment of a FFT. The processing device 204 is further programmed to apply the plurality of timing relationships to the first incoming data and responsively determine a plurality of achievable interference metrics using the determine timing relationship module 206. Each of the plurality of achievable interference metrics is associated with a selected one of the plurality of timing relationships.

The processing device 204 can be further programmed to choose a preferred interference metric from amongst the plurality of achievable interference metrics and identify a preferred timing relationship from amongst the plurality of timing relationships. The preferred timing relationship is associated with the preferred interference metric. The receiver 202 further receives second incoming data and the processing device 204 is further programmed to demodulate the second incoming data using the preferred timing relationship and present the demodulated second incoming data at the output of the interface 208.

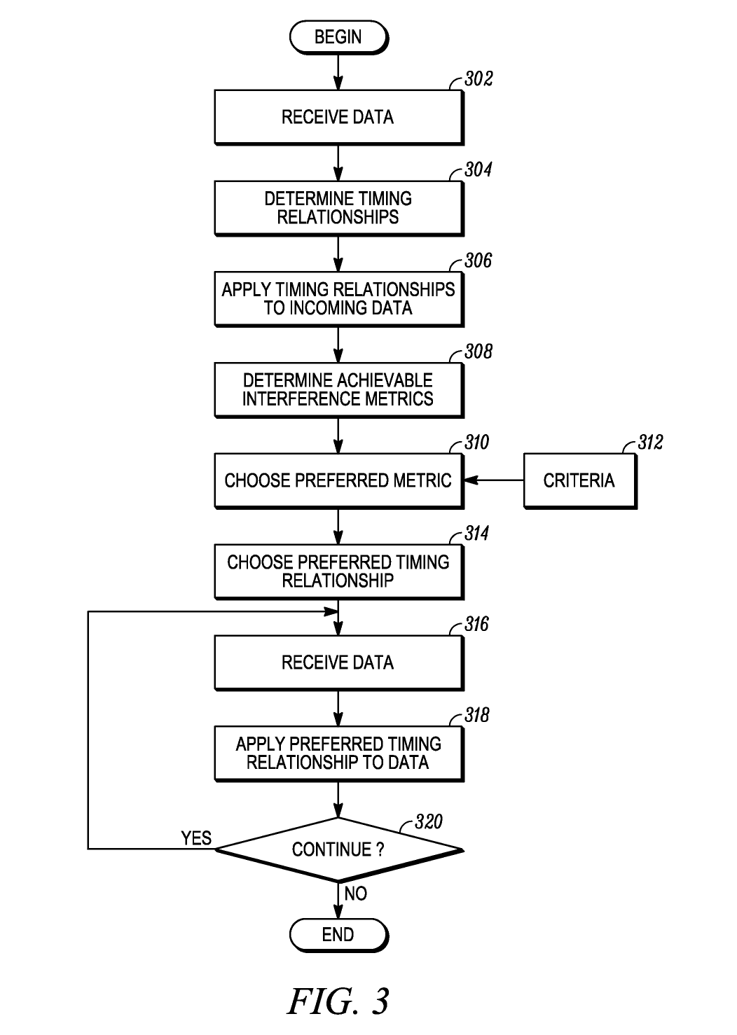

Referring now to FIG. 3, one approach for selecting optimum timing synchronization is described. At step 302, data is received. At step 304, a timing relationship is determined using the incoming data, which may be OFDM symbols. At step 306, the timing relationship is applied to the incoming data. At step 308, achievable interference metrics, such as achievable S/I ratios, are determined.

At step 310, criteria 312 are applied to achievable metric to choose a preferred metric. In one example, the maximum may be selected. In another example, the minimum metric may be selected. At step 316, additional data is received. At step 318, the preferred timing relationship is applied to this subsequent data. At step 320 it is determined if the other data is coming. If the answer is affirmative control returns to step 316 and execution continues as described above. If the answer is negative, execution ends.

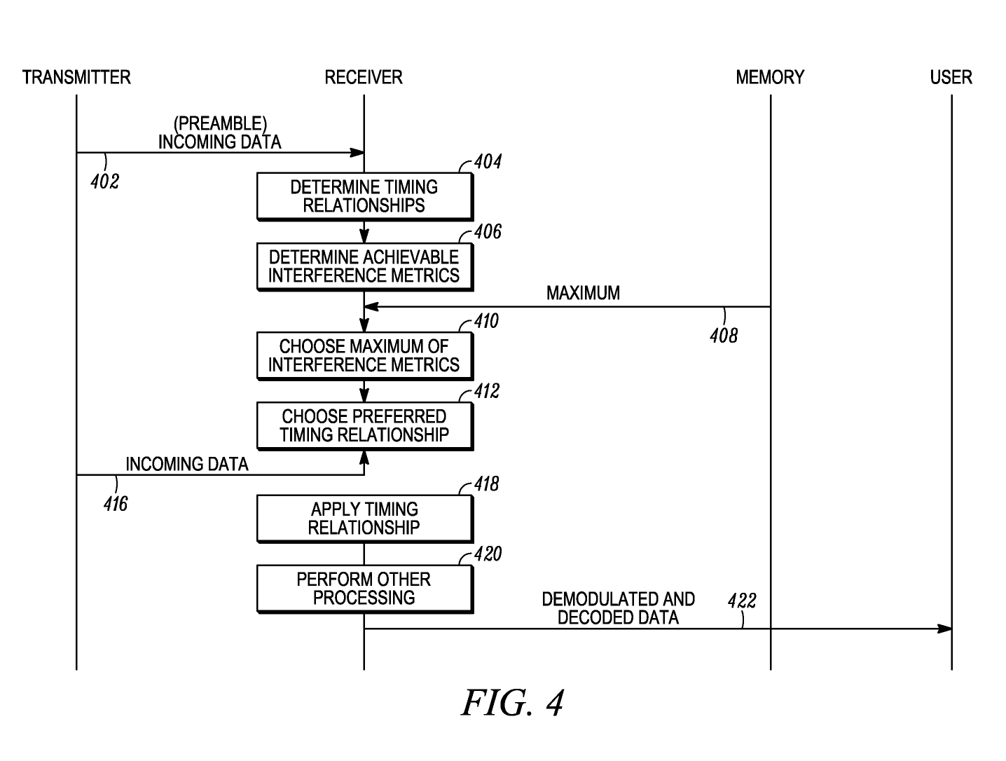

Referring now to FIG. 4, another approach for selecting optimum timing synchronization is described. At step 402, incoming data, for example, the preamble of a packet is received at a receiver. At step 404, a plurality of timing relationships is determined. At step 406, a plurality of achievable interference metrics are determined, for example, S/I ratios. At step 408, a rule from memory is retrieved. In this example, the rule indicates that the maximum achievable interference metric is the preferred metric to be chosen. At step 410, the maximum achievable interference metric is chosen. At step 412, the preferred timing relationship is chosen and this timing relationship relates to or is associated with the maximum interference metric.

At step 416, incoming data is received. At step 418, the preferred timing relationship is applied to the data. At step 420, other processing (e.g., de-interleaving and decoding) is performed. At step 422, the demodulated and decoded data is made available to a user.

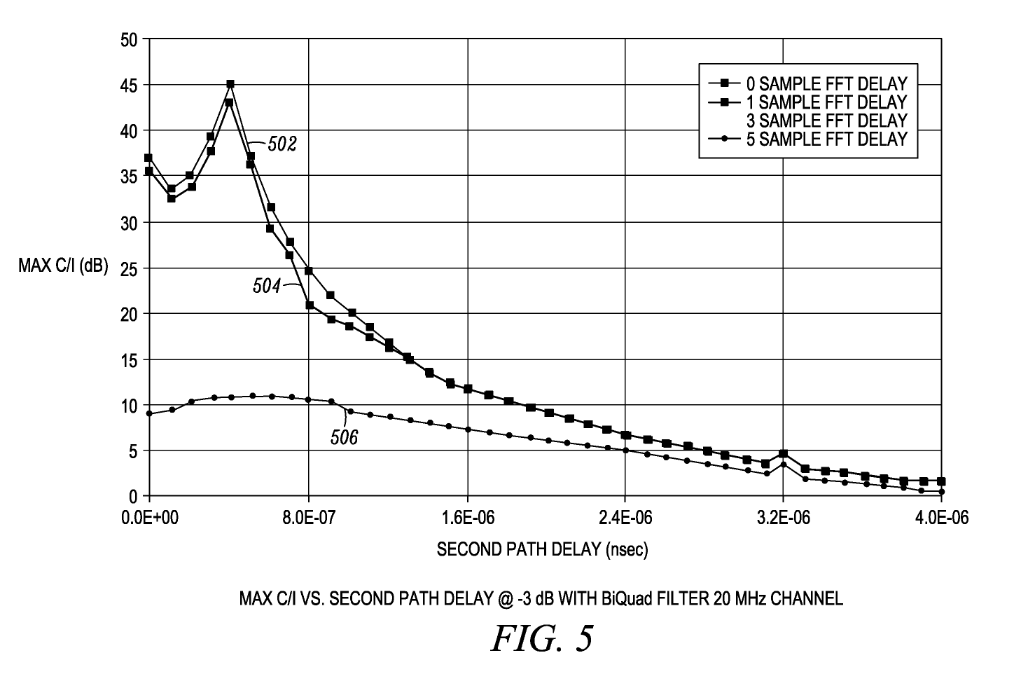

Referring now to FIG. 5, a graph showing timing relationships 502, 504, and 506 is described. In this example, different curves show different timing relationships. The timing relationships 502, 504, and 506 relate to the relative alignment of the received signal and the FFT window and the horizontal axis shows the amount of delay in a transmission path. S/I max is given as a function of a second path delay for several different delays of the FFT window. As can be seen, the maximum achievable S/I ratio is sensitive to the receiver timing synchronization and a maximum achievable S/I can be chosen and is associated with a particular receiver timing relationship 502, 504, or 506.

Thus, approaches are provided that provide optimum timing relationships to achieve optimum synchronization for incoming data in OFDM systems. The approaches described herein are relatively easy to implement and provide for improved system performance. Consequently, user satisfaction with these systems is also enhanced.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

What is claimed is:

1. A method of synchronizing communications being conducted in an Orthogonal Frequency Division Modulation (OFDM) communication system comprising:
receiving first incoming data comprising at least one OFDM symbol;
determining a plurality of timing relationships, each of the plurality of timing relationships relating to an alignment window of a fast Fourier transform (FFT);
applying each of the plurality of timing relationships to the first incoming data and responsively determining a plurality of achievable interference metrics associated with the first incoming data, each of the plurality of achievable interference metrics being associated with a selected one of the plurality of timing relationships; and
choosing a preferred interference metric from amongst the plurality of achievable interference metrics and identifying a preferred timing relationship from amongst the plurality of timing relationships, the preferred timing relationship being associated with the preferred interference metric.

2. The method of claim 1 wherein the preferred interference metric is chosen from a group comprising a maximum achievable interference metric and a minimum achievable interference metric.

3. The method of claim 1 further comprising receiving second incoming data comprising a subsequent sequence of OFDM symbols and demodulating the second incoming data using the preferred timing relationship.

4. The method of claim 1 wherein each of the achievable interference metrics comprises a Signal/Interference (S/I) ratio.

5. The method of claim 4 wherein the S/I ratio is defined as:
$$〈 S 〉 / {〈 I 〉}_{max} = \frac{{‖ μ\_data ‖}^{2}}{{\sum }_{i} {γ}_{i} {‖ {f}_{i} ‖}^{2} + {‖ μ\_error ‖}^{2}}$$
$$where$$
$$μ\_data = ( {f}_{0} , {f}_{1} , … , {f}_{15} , {f}_{16} , \frac{63}{64} {f}_{17} , … , \frac{17}{64} {f}_{63} ) + ( \frac{16}{64} {f}_{64} , \frac{15}{64} {f}_{65} , … , \frac{1}{64} {f}_{79} , 0 , 0 , … , 0 ) , and + ( 0 , \frac{1}{64} {f}_{- 63} , … \frac{62}{64} {f}_{- 2} , \frac{63}{64} {f}_{- 1} )$$
$$μ\_error = ( 0 , … , 0 , \frac{1}{64} {f}_{17} , \frac{2}{64} {f}_{18} , … , \frac{16}{64} {f}_{32} , \frac{33}{128} {f}_{33} , \frac{34}{128} {f}_{34} , … , \frac{63}{128} {f}_{63} ) + ( \frac{64}{128} {f}_{64} , \frac{65}{128} {f}_{65} , … , \frac{79}{128} {f}_{79} , \frac{80}{128} {f}_{80} , \frac{79}{128} {f}_{81} , … , \frac{33}{128} {f}_{127} ) + ( \frac{32}{128} {f}_{128} , \frac{31}{64} {f}_{129} , … , \frac{1}{64} {f}_{159} , 0 , 0 , … , 0 ) + ( \frac{64}{128} {f}_{- 64} , \frac{63}{128} {f}_{- 63} , … , \frac{2}{128} {f}_{- 2} \frac{1}{128} {f}_{- 1} ) + ( 0 , \frac{1}{128} {f}_{- 127} , \frac{2}{128} {f}_{- 126} , … , \frac{63}{128} {f}_{- 65} ) ,$$
and γₖ is a multipath interference coefficient given by
γₖ=γ_{ISI,k}+γ_{ITI,k},
where γ_{ISI,k} is the portion of the multipath interference coefficient due to intersymbol interference given by
$${γ}_{ISI , k} = \{ \begin{matrix}0 & 0 \leq k \leq 16 \\ {( \frac{k - 16}{64} )}^{2} & 17 \leq k \leq 79 \\ {( \frac{k}{64} )}^{2} & - 63 \leq k \leq - 1 \\ 1 & \vert k \vert \geq 64 and mod ( k , 80 ) \leq 16 \\ \begin{matrix}{( \frac{mod ( k , 80 ) - 16}{64} )}^{2} + \\ {( \frac{80 - mod ( k , 80 )}{64} )}^{2}\end{matrix} & otherwise\end{matrix} ,$$
and γ_{ITI, k} is the portion of the multipath interference coefficient due to inter-tone interference given by
$${γ}_{ITI , k} = \{ \begin{matrix}0 & mod ( k , 80 ) \leq 16 \\ \frac{4}{52 {π}^{2}} {\sum }_{i = 1}^{51} ( 52 - i ) \frac{{sin}^{2} ( π i mod ( k , 80 ) / 64 )}{{i}^{2}} & else\end{matrix} .$$

6. The method of claim 4 wherein the S/I ratio is defined as:
$$〈 S 〉 / {〈 I 〉}_{max} = \frac{{‖ μ\_data ‖}^{2}}{{\sum }_{i} {γ}_{i} {‖ {f}_{i} ‖}^{2}}$$
$$where$$
$$μ\_data = ( {f}_{0} , {f}_{1} , … , {f}_{15} , {f}_{16} , \frac{63}{64} {f}_{17} , … , \frac{17}{64} {f}_{63} ) + ( \frac{16}{64} {f}_{64} , \frac{15}{64} {f}_{65} , … , \frac{1}{64} {f}_{79} , 0 , 0 , … , 0 ) + ( 0 , \frac{1}{64} {f}_{- 63} , … \frac{62}{64} {f}_{- 2} , \frac{63}{64} {f}_{- 1} ) ,$$
and γₖ is a multipath interference coefficient given by
γₖ=γ_{ISI,k}+γ_{ITI,k},
where γ_{ISI,k} is the portion of the multipath interference coefficient due to intersymbol interference given by
$${γ}_{ISI , k} = \{ \begin{matrix}0 & 0 \leq k \leq 16 \\ {( \frac{k - 16}{64} )}^{2} & 17 \leq k \leq 79 \\ {( \frac{k}{64} )}^{2} & - 63 \leq k \leq - 1 \\ 1 & \vert k \vert \geq 64 and mod ( k , 80 ) \leq 16 \\ \begin{matrix}{( \frac{mod ( k , 80 ) - 16}{64} )}^{2} + \\ {( \frac{80 - mod ( k , 80 )}{64} )}^{2}\end{matrix} & otherwise\end{matrix} ,$$
and γ_{ITI,k} is the portion of the multipath interference coefficient due to inter-tone interference given by
$${γ}_{ITI , k} = \{ \begin{matrix}0 & mod ( k , 80 ) \leq 16 \\ \frac{4}{52 {π}^{2}} {\sum }_{i = 1}^{51} ( 52 - i ) \frac{{sin}^{2} ( π i mod ( k , 80 ) / 64 )}{{i}^{2}} & else\end{matrix} .$$

7. The method of claim 4 wherein the S/I ratio is defined as:
$$〈 S 〉 / {〈 I 〉}_{max} = \frac{{‖ μ\_data ‖}^{2}}{{\sum }_{i} {γ}_{i} {‖ {f}_{i} ‖}^{2}} .$$

8. The method of claim 1 wherein the first incoming data is received over a channel and the channel has a delay spread that is greater than a cyclic prefix associated with the channel.

9. The method of claim 1 wherein the first incoming data comprises a preamble.

10. A method for synchronizing communications being conducted in an Orthogonal Frequency Division Modulation (OFDM) communication system comprising:
in an OFDM system:
determining a plurality of timing relationships;
applying the plurality of timing relationships to first incoming data and responsively determining at least two achievable interference ratios, wherein each of the plurality of timing relationships is associated with a different one of the at least two achievable interference ratios;
choosing a maximum achievable interference ratio from the amongst the at least two achievable interference ratios;
identifying a preferred timing relationship from amongst the plurality of timing relationships, the preferred timing relationship corresponding to the maximum achievable interference ratio; and
applying the preferred timing relationship to second incoming data in order to demodulate the second incoming data.

11. The method of claim 10 wherein each of the plurality of timing relationships is associated with an alignment window of a fast Fourier transform (FFT).

12. The method of claim 10 wherein each of the plurality of achievable interference ratios comprises a signal/interference (S/I) ratio.

13. The method of claim 12 wherein the S/I ratio is defined as:
$$〈 S 〉 / {〈 I 〉}_{max} = \frac{{‖ μ\_data ‖}^{2}}{{\sum }_{i} {γ}_{i} {‖ {f}_{i} ‖}^{2} + {‖ μ\_error ‖}^{2}}$$
$$where$$
$$μ\_data = ( {f}_{0} , {f}_{1} , … , {f}_{15} , {f}_{16} , \frac{63}{64} {f}_{17} , … , \frac{17}{64} {f}_{63} ) + ( \frac{16}{64} {f}_{64} , \frac{15}{64} {f}_{65} , … , \frac{1}{64} {f}_{79} , 0 , 0 , … , 0 ) , and + ( 0 , \frac{1}{64} {f}_{- 63} , … \frac{62}{64} {f}_{- 2} , \frac{63}{64} {f}_{- 1} )$$
$$μ\_error = ( 0 , … , 0 , \frac{1}{64} {f}_{17} , \frac{2}{64} {f}_{18} , … , \frac{16}{64} {f}_{32} , \frac{33}{128} {f}_{33} , \frac{34}{128} {f}_{34} , … , \frac{63}{128} {f}_{63} ) + ( \frac{64}{128} {f}_{64} , \frac{65}{128} {f}_{65} , … , \frac{79}{128} {f}_{79} , \frac{80}{128} {f}_{80} , \frac{79}{128} {f}_{81} , … , \frac{33}{128} {f}_{127} ) + ( \frac{32}{128} {f}_{128} , \frac{31}{64} {f}_{129} , … , \frac{1}{64} {f}_{159} , 0 , 0 , … , 0 ) + ( \frac{64}{128} {f}_{- 64} , \frac{63}{128} {f}_{- 63} , … , \frac{2}{128} {f}_{- 2} \frac{1}{128} {f}_{- 1} ) + ( 0 , \frac{1}{128} {f}_{- 127} , \frac{2}{128} {f}_{- 126} , … , \frac{63}{128} {f}_{- 65} ) ,$$
and γₖ is a multipath interference coefficient given by
γₖ=γ_{ISI,k}+γ_{ITI,k},
where γ_{ISI,k} is the portion of the multipath interference coefficient due to intersymbol interference given by
$${γ}_{ISI , k} = \{ \begin{matrix}0 & 0 \leq k \leq 16 \\ {( \frac{k - 16}{64} )}^{2} & 17 \leq k \leq 79 \\ {( \frac{k}{64} )}^{2} & - 63 \leq k \leq - 1 \\ 1 & \vert k \vert \geq 64 and mod ( k , 80 ) \leq 16 \\ \begin{matrix}{( \frac{mod ( k , 80 ) - 16}{64} )}^{2} + \\ {( \frac{80 - mod ( k , 80 )}{64} )}^{2}\end{matrix} & otherwise\end{matrix} ,$$
and γ_{ITI,k} is the portion of the multipath interference coefficient due to inter-tone interference given by
$${γ}_{ITI , k} = \{ \begin{matrix}0 & mod ( k , 80 ) \leq 16 \\ \frac{4}{52 {π}^{2}} {\sum }_{i = 1}^{51} ( 52 - i ) \frac{{sin}^{2} ( π i mod ( k , 80 ) / 64 )}{{i}^{2}} & else\end{matrix} .$$

14. The method of claim 12 wherein the S/I ratio is defined as:
$$〈 S 〉 / {〈 I 〉}_{max} = \frac{{‖ μ\_data ‖}^{2}}{{\sum }_{i} {γ}_{i} {‖ {f}_{i} ‖}^{2}}$$
$$where$$
$$μ\_data = ( {f}_{0} , {f}_{1} , … , {f}_{15} , {f}_{16} , \frac{63}{64} {f}_{17} , … , \frac{17}{64} {f}_{63} ) + ( \frac{16}{64} {f}_{64} , \frac{15}{64} {f}_{65} , … , \frac{1}{64} {f}_{79} , 0 , 0 , … , 0 ) + ( 0 , \frac{1}{64} {f}_{- 63} , … \frac{62}{64} {f}_{- 2} , \frac{63}{64} {f}_{- 1} ) ,$$
and γₖ is a multipath interference coefficient given by
γₖ=γ_{ISI,k}+γ_{ITI,k},
where γ_{ISI,k} is the portion of the multipath interference coefficient due to intersymbol interference given by
$${γ}_{ISI , k} = \{ \begin{matrix}0 & 0 \leq k \leq 16 \\ {( \frac{k - 16}{64} )}^{2} & 17 \leq k \leq 79 \\ {( \frac{k}{64} )}^{2} & - 63 \leq k \leq - 1 \\ 1 & \vert k \vert \geq 64 and mod ( k , 80 ) \leq 16 \\ \begin{matrix}{( \frac{mod ( k , 80 ) - 16}{64} )}^{2} + \\ {( \frac{80 - mod ( k , 80 )}{64} )}^{2}\end{matrix} & otherwise\end{matrix} ,$$
and γ_{ITI,k} is the portion of the multipath interference coefficient due to inter-tone interference given by
$${γ}_{ITI , k} = \{ \begin{matrix}0 & mod ( k , 80 ) \leq 16 \\ \frac{4}{52 {π}^{2}} {\sum }_{i = 1}^{51} ( 52 - i ) \frac{{sin}^{2} ( π i mod ( k , 80 ) / 64 )}{{i}^{2}} & else\end{matrix} .$$

15. The method of claim 12 wherein the S/I ratio is defined as:
$$〈 S 〉 / {〈 I 〉}_{max} = \frac{{‖ μ\_data ‖}^{2}}{{\sum }_{i} {γ}_{i} {‖ {f}_{i} ‖}^{2}} .$$

16. An apparatus for synchronizing communications being conducted in an Orthogonal Frequency Division Modulation (OFDM) system comprising:
a receiver for receiving first incoming data;
an interface having an output; and
a processing device coupled to the receiver and the interface, the processing device being programmed to determine a plurality of timing relationships, wherein each of the plurality of timing relationships relates to an alignment of a fast Fourier transform (FFT), the processing device being further programmed to apply the plurality of timing relationships to the first incoming data and responsively determine a plurality of achievable interference metrics, each of the plurality of achievable interference metrics being associated with a selected one of the plurality of timing relationships, the processing device being further programmed to choose a preferred interference metric from amongst the plurality of achievable interference metrics and identify a preferred timing relationship from amongst the plurality of timing relationships, the preferred timing relationship being associated with the preferred interference metric, and wherein the receiver further receives second incoming data and the processing device is further programmed to demodulate the second incoming data using the preferred timing relationship and present the demodulated second incoming data at the output of the interface.

17. The apparatus of claim 16 wherein the first incoming data comprises a plurality of OFDM symbols.

18. The apparatus of claim 16 wherein each of the achievable interference metrics comprises a Signal/Interference (S/I) ratio.

19. The apparatus of claim 16 wherein the preferred interference metric is chosen from a group comprising a maximum achievable interference metric and a minimum achievable interference metric.
